(19) United States
(12) Patent Application Publication
(10) Pub. No.: US 2026/0073330 A1
(43) Pub. Date: Mar. 12, 2026

(54) INFORMATION PROCESSING APPARATUS AND INFORMATION PROCESSING METHOD

(71) Applicant: Toshiba Tec Kabushiki Kaisha, Tokyo (JP)

(72) Inventor: Kazuhiro KAMIMURA, Mishima Shizuoka (JP)

(21) Appl. No.: 19/261,689

(22) Filed: Jul. 7, 2025

(30) Foreign Application Priority Data
Sep. 12, 2024 (JP) 2024-158437

(51) Int. Cl. G06Q 10/0631

(52) U.S. Cl. CPC G06Q 10/06316

(57) ABSTRACT

According to an embodiment, an information processing apparatus stores, for each workflow that defines an assignment order of tasks to be executed in sequence by a plurality of operators, a task history in which a type of the task executed by each of the operators and a date and time at which the task has been executed are associated with each other. The information processing apparatus calculates an average time for each type of the task from a time when an order is assigned to the operator to a time when the operator executes the task, on the basis of the stored task history. Further, the information processing apparatus sends a notification to an operator who has not performed the task at a timing based on the average time corresponding to the type of the task.

### CROSS-REFERENCE TO RELATED APPLICATIONS

This application is based upon and claims the benefit of priority from the prior Japanese Patent Application No. 2024-158437, filed on Sep. 12, 2024, the entire contents of which are incorporated herein by reference.

### FIELD

Embodiments described herein generally relate to an information processing apparatus and an information processing method.

### BACKGROUND

Workflow systems are known in which document data such as various application forms is circulated for approval or settlement in organizations such as companies. In a workflow system, for example, when an application form is created, a drafter enters necessary information by selecting an item from multiple pull-down options or inputting a text of free descriptions. When the drafter completes his/her task, the document data is circulated to operators such as a person who gives a proof mark and an approver according to a circulation route.

By the way, some conventional workflow systems send a notification to prompt the execution of a task to an operator who performs a task such as approval when a request occurs or when a deadline is exceeded. However, the conventional workflow systems send a notification mechanically at a fixed timing, and thus there are cases where operators are often less attentive to the notification and where the workflow systems are less effective in preventing the occurrence of task omissions and delays. Therefore, there is a need for a technology that can provide work support that reduces the occurrence of task omissions and delays.

### BRIEF DESCRIPTION OF THE DRAWINGS

FIG. 1 is a block diagram illustrating a work support system according to an embodiment.

FIG. 2 is a diagram showing an example of a data configuration of a workflow storage area according to the embodiment.

FIG. 3 is a flowchart showing an example of processing related to workflow management, which is performed by a server according to the embodiment.

FIG. 4 is flowchart showing an example of processing related to calculation of an average work time, which is performed by the server according to the embodiment.

FIG. 5 is flowchart showing an example of processing related to a reminder notification, which is sent by the server according to the embodiment.

### DETAILED DESCRIPTION

According to one embodiment, an information processing apparatus includes a communication interface, a storage device, and a processing circuit. The communication interface communicates with a plurality of user terminals respectively operated by a plurality of operators via a network. The storage device stores data of a workflow that defines an assignment order of tasks to be executed in sequence by the plurality of operators. The data of the workflow includes a task history in which a type of the task executed by each of the operators and a date and time at which the task has been executed are associated with each other. The processing circuit records, in the storage device, when an operation for data included in the workflow is received from the user terminal operated by each operator via the communication interface, the type of the task corresponding to contents of the operation and the date and time at which the task has been executed, associated with each other in the task history corresponding to the operator who has performed the operation in the operated workflow. The processing circuit calculates an average time for each type of the task from a time when an order is assigned to the operator to a time when the operator executes the task, on a basis of the task history, for each workflow. Further, the processing circuit sends a notification to an operator who has not performed the task at a timing based on the average time corresponding to the type of the task.

Hereinafter, embodiments will be described with reference to the drawings. In each drawing, the same constituent elements are denoted by the same reference symbols as far as possible, and redundant description will be omitted.

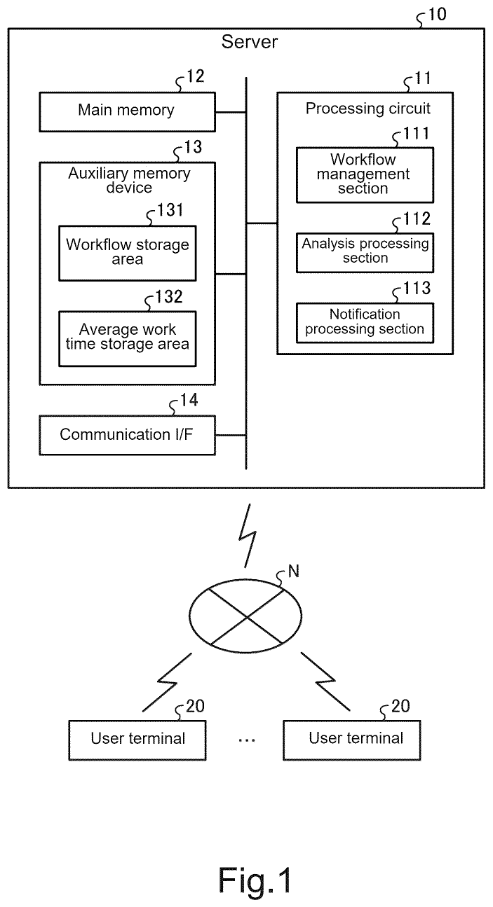

FIG. 1 is a block diagram illustrating a work support system 1 according to an embodiment. The work support system 1 includes a server 10 and user terminals 20.

The server 10 and the user terminals 20 are connected to each other communicatively via a network N. For example, the network N includes one or more networks of various networks such as the Internet, a mobile communication network, and a local area network (LAN). The one or more networks may include a wireless network or a wired network. Note that the number of user terminals 20 included in the work support system 1 is not limited to the illustrated example.

The server 10 is an example of an information processing apparatus. The server 10 collects data and processes the collected data. The server 10 is communicatively connected to the user terminal 20 via the network N. The server 10 receives various types of data from the user terminal 20 and outputs various types of data to the user terminal 20. The server 10 is an example of an information processing apparatus. A configuration example of the server 10 will be described later. The server 10 may be a server used in a cloud service.

The server 10 provides a workflow service for performing processing from creation of an application form or the like to approval or settlement. The workflow service provides, for example, a workflow of creating and managing document data. The workflow includes a series of tasks in which a drafter creates document data and circulates the document data to the next-order operator according to a predetermined circulation route. The creation of document data includes inputting necessary information, attaching necessary documents, and the like. The circulation includes notifying the next-order operator. The next-order operator checks the document data created by the drafter. The next-order operator may include a person who gives a proof mark, an approver, and the like. Further, the operator may include the drafter.

The workflow service may include a plurality of workflows. The workflow defines an assignment order of tasks to be executed in sequence by a plurality of operators. The workflow is set, for example, for each operation that can be viewed or performed by a plurality of operators in an organization. The organization includes operators who perform tasks from the start to the end of a workflow. The organization is, for example, a company, a corporation, or an office. The organization is not limited to those described above, but may be a community including a plurality of operators. The workflow may include, for example, a series of tasks such as drafting, approval, and settlement. The workflow includes, for example, creating various application forms such as a transportation expense application and a facility use application, creating a report, and creating a written request. The workflow may include information sharing within an organization. The workflow may be set for each operation, task, or topic.

The user terminal 20 is a device that can communicate with another electronic apparatus. The user terminal 20 is a device that is used by a drafter or an operator of a workflow. The drafter is also referred to as a creator of document data in the workflow. For example, the user terminal 20 is a personal computer (PC), a smartphone, a tablet terminal, or the like, but it is not limited thereto. The user of the user terminal 20 uses the workflow service via the user terminal 20.

Next, a configuration example of the server 10 will be described. As shown in FIG. 1, the server 10 includes a processing circuit 11, a main memory 12, an auxiliary memory device 13, and a communication interface (I/F) 14. The parts included in the server 10 are connected to be capable of inputting and outputting signals to and from each other.

The processing circuit 11 is a processor corresponding to the central part of the server 10 and comprehensively controls the operation of the server 10. The processing circuit 11 is an element that configures the computer of the server 10. For example, the processing circuit 11 is a central processing unit (CPU), but it is not limited thereto. The processing circuit 11 may include various circuits, such as a real time clock (RTC), capable of timing the current date and time.

The processing circuit 11 expands in the main memory 12 a program stored beforehand in the main memory 12 or the auxiliary memory device 13. The program is a program that causes the processing circuit 11 of the server 10 to implement each of the parts to be described below. The processing circuit 11 executes the program expanded in the main memory 12 to execute various operations.

The main memory 12 corresponds to the main storage part of the server 10. The main memory 12 is an element constituting the computer of the server 10. The main memory 12 includes a non-volatile memory area and a volatile memory area. The main memory 12 stores an operating system or a program in the non-volatile memory area. The main memory 12 uses the volatile memory area as a work area in which data is rewritten by the processing circuit 11 as appropriate. For example, the main memory 12 includes a read only memory (ROM) as a non-volatile memory area. For example, the main memory 12 includes a random access memory (RAM) as a volatile memory area. The main memory 12 stores a program.

The auxiliary memory device 13 corresponds to the auxiliary storage part of the server 10. The auxiliary memory device 13 is an element constituting the computer of the server 10. The auxiliary memory device 13 is an electric erasable programmable read-only memory (EEPROM) (registered trademark), a hard disc drive (HDD), a solid state drive (SSD), or the like. The auxiliary memory device 13 stores the program described above, data used by the processing circuit 11 to perform various types of processing, and data generated by the processing of the processing circuit 11. The auxiliary memory device 13 stores the program described above.

The auxiliary memory device 13 stores a workflow storage area 131. In this example, a workflow is assumed to be a flow in which a creator creates document data and circulates it to an operator. The document data is draft data created by a drafter of the workflow. For example, if the workflow is to create an application form, the document data represents input data of an application form.

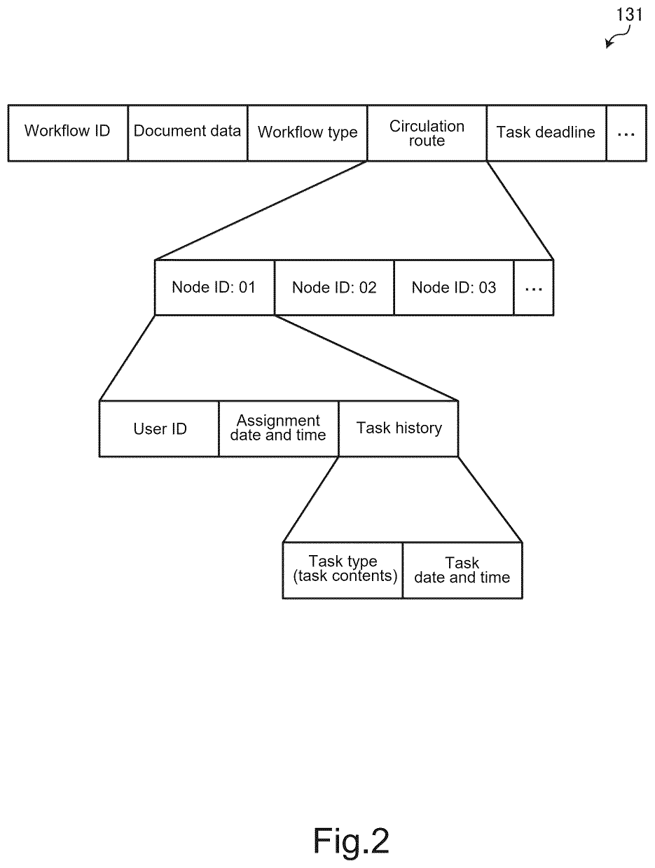

FIG. 2 is a diagram showing an example of a data configuration of the workflow storage area 131 according to the embodiment. The workflow storage area 131 includes, for example, information such as a workflow ID, document data, a workflow type, a circulation route, and a task deadline.

The workflow ID is an identifier for identifying a workflow and is a unique ID provided to each workflow. The document data is document data created by the drafter of the workflow or information indicating a location where the document data is stored. The workflow type is information indicating the type of document data such as an application form, that is, the type of workflow.

The circulation route includes node IDs (hereinafter also referred to as nodes) that indicate a circulation order in which document data is circulated to operators, that is, a task assignment order. The operator indicates a person who performs a task on the document data in the workflow. The node holds, for example, information such as a numerical value that indicates the order of circulation. For example, when data is circulated to three operators, nodes 1 to 3 are stored in the circulation route.

In each node, information such as a user ID, an assignment date and time, and a task history are stored in association with each other. The user ID is identification information that uniquely identifies an operator. The assignment date and time is information that indicates the date and time at which the circulation of document data is assigned to the operator of the node, that is, the date and time at which a task is assigned to the operator. For example, in the assignment date and time of the node whose circulation order is the first, the date and time at which the circulation of the workflow is started is registered. In addition, in the assignment date and time of the next and subsequent nodes other than the first node in the circulation order, the date and time at which an approval task is executed at an immediately preceding node is registered. The approval task will be described later.

The task history includes a task type of a task performed on the document data, a task date and time (execution date and time) at which a task has been executed, and the like. The task type includes, for example, creation, update, correction, approval, and return. The task type is set for a task that can be executed according to the type of workflow or the like. The task type may be set for a task that can be executed according to the authority of an operator or the like. Note that if a plurality of tasks are executed at the same node due to return from the next-order node or other reasons, pairs of the task type and the task date and time are recorded in the task history of that node in the order of execution. In the following, among the tasks that can be executed by operators, a task of advancing the order to the next-order operator and a task of approving the task executed in the preceding order are also referred to as “approval task”.

The task deadline is information, such as a date and a time, indicating the deadline for completing the execution of the workflow. The task deadline may be set by the drafter, or a predetermined period of time may be set on the basis of the date and time at which draft data is created. Further, the task deadline may also be set for each node.

The workflow storage area 131 may contain other information related to the workflow. For example, the workflow storage area 131 may contain rank information such as a degree of importance and a degree of urgency for each workflow. In addition, the workflow storage area 131 may store a task status of the workflow. The task status indicates a status of a task with respect to the workflow. The task status indicates, for example, a state in which tasks of all operators are completed or uncompleted. The information related to the workflow can be updated as appropriate.

The auxiliary memory device 13 includes an average work time storage area 132. The average work time storage area 132 stores average work time information. The average work time information can be updated as appropriate in accordance with work performance of each operator.

The average work time information is information in which a task type and an average work time are associated with each other. The task type is a task type of a task executed at each node of the workflow. The average work time is the average of time from the time when a task of the task type becomes ready to be executed to the time when the task is actually executed. The average work time information is stored by associating the average work time and the task type of approval task among a plurality of task types.

The average work time storage area 132 may contain other information other than the average work time information related to the task type. For example, the average work time storage area 132 may contain other average work time information that is associated with an average work time for each type of the workflow (hereinafter, also referred to as WF average work time information). The average work time of the WF average work time information is the average of time from the start of the circulation of the workflow to the execution of the approval task at the last node.

The auxiliary memory device 13 may store areas other than the workflow storage area 131 and the average work time storage area 132. The auxiliary memory device 13 may store a user management area that stores and manages user IDs of operators including the drafter. The user management area stores user management information in which information such as user's affiliation, job title, and authority is associated with the user ID of each user.

The communication interface 14 includes various interfaces that connect the server 10 to other apparatuses communicatively via the network N according to a predetermined communication protocol.

Note that the hardware configuration of the server 10 is not limited to the configuration described above. The server 10 allows omission and modification of the constituent elements described above and addition of new constituent elements as appropriate.

Next, the functional configuration implemented by the processing circuit 11 described above will be described.

The processing circuit 11 implements a workflow management section 111, an analysis processing section 112, and a notification processing section 113. Each section implemented by the processing circuit 11 can also be referred to as each function. Each section implemented by the processing circuit 11 can also be referred to as being implemented by a controller including the processing circuit 11 and the main memory 12.

The workflow management section 111 manages a workflow. The workflow management section 111 stores the document data created by the drafter in the workflow storage area 131 in association with the workflow ID, the workflow type, the circulation route, the task deadline, and the like. The workflow type may be set by the drafter or may be set by the workflow management section 111 in accordance with the created document data. The circulation order, the circulation count (number of nodes), and the user ID included in the circulation route may be set by the drafter or may be automatically set by the workflow management section 111 in accordance with the affiliation of the drafter, a WD type, and the like. The task deadline may be set by the drafter or may be automatically set by the workflow management section 111 in accordance with the current date and time, a WD type, and the like.

The workflow management section 111 provides a workflow stored in the workflow storage area 131 to an operator of a user ID set for each node of the circulation route. Specifically, the workflow management section 111 provides the document data included in that workflow to the user terminal 20, which is to be operated by an operator of a user ID set for each node of the circulation route, in a viewable and operable manner. In addition, the workflow management section 111 receives an operation (task) for the document data from the operator in the circulation order set for each node. Note that the workflow management section 111 may provide a screen (user interface) for supporting the operation for the workflow to the user terminal 20.

Upon reception of the operation for the workflow from the user terminal 20, the workflow management section 111 registers the result of the task corresponding to the operation in the task history of the workflow storage area 131. Specifically, when receiving the operation for the document data, the workflow management section 111 registers the task type corresponding to the operation and the date and time at which the operation has been performed (task date and time) in the task history of the node associated with the user ID of the operator who has performed the operation, among the nodes set for the circulation route. Note that the user terminal 20 transmits the user ID of the operator who operates that terminal to the server 10 when accessing the server 10.

In addition, the workflow management section 111 advances the circulation order to the next order or returns it to the preceding order according to the contents of the operation (task type) received from the operator. For example, if the operation of return is received, the workflow management section 111 returns the circulation order to the preceding order. For example, if the operation of performing an approval task such as approval is received, the workflow management section 111 advances the circulation order to the next order. Note that if the circulation order is advanced to the next order, the workflow management section 111 registers the task date and time at which the approval task has been performed at the node of the preceding order, in the assignment date and time of the next-order node.

The analysis processing section 112 is an example of a calculation section and calculation means. The analysis processing section 112 calculates an average work time for each task type. The analysis processing section 112 calculates an average work time for each task type from the time when the order is assigned to an operator to the time when the operator executes the operation, on the basis of the task history of each workflow recorded in the workflow storage area 131.

Specifically, the analysis processing section 112 accumulates, for the approval task registered in the task history of each node, an elapsed time for each type of approval task from the assignment date and time of that node to the task date and time at which the approval task has been performed. The analysis processing section 112 then calculates an average work time for each type of approval task by dividing the accumulated time for each type of approval task (cumulative time) by the total number of nodes from which the operating times of that type are collected. After calculating the average work time, the analysis processing section 112 associates the type of approval task and the calculated average work time with each other and stores them in the average work time storage area 132.

If a plurality of approval tasks are registered in the task history of the same node due to reasons such as return, the analysis processing section 112 may accumulate the time from the assignment date and time to the last task date and time or may accumulate the time to the oldest task date and time. For example, as an accumulation method for the case where a plurality of approval tasks are registered, a configuration capable of selecting the latest or oldest task date and time for accumulation may be provided.

In addition, the analysis processing section 112 may calculate an average work time for each type of workflow. In this case, the analysis processing section 112 accumulates, for the workflow in which the tasks of the operators have been completed, the time for each type of workflow from the assignment date and time of the first node to the task date and time of the approval task recorded in the task history of the last node. The analysis processing section 112 then calculates an average work time for each type of workflow (WF average work time) by dividing the accumulated time for each type of workflow (cumulative time) by the total number of workflows from which the operating times of that type are collected. After calculating the WF average work time, the analysis processing section 112 associates the type of approval task and the calculated average work time with each other and stores them in the average work time storage area 132.

Note that the timing at which the analysis processing section 112 calculates the average work time is not specified particularly and can be set discretionally. For example, the analysis processing section 112 may calculate the average work time at a predetermined cycle (e.g., daily, monthly, etc.). In addition, the analysis processing section 112 may also calculate the average work time in response to an operation from the operator.

The notification processing section 113 is an example of a notification section and notification means. The notification processing section 113 sends a notification for prompting the execution of a task (hereinafter, referred to as “reminder notification”) to an operator who has not yet performed the task at a timing based on the average work time corresponding to the type of task, on the basis of the workflow stored in the workflow storage area 131. The operator who has not yet performed the task is an operator of a node at which no approval task is recorded in the task history in spite of having the registered assignment date and time. Note that, among the operators who have not yet performed tasks, an operator whose task history is empty may be classified as an operator who “has not yet started the task”, and an operator whose latest task type recorded in the task history is other than the approval task may be classified as an operator who “has already started the task”.

Specifically, the notification processing section 113 sends a reminder notification when a predetermined period of time based on the average work time of the type of approval task performed at a node has elapsed since the assignment date and time of that node to which the operator who has not yet executed the task is assigned. For example, the notification processing section 113 sends a reminder notification when X% of the average work time has elapsed since the assignment date and time. As an example, the notification processing section 113 sends a reminder notification when 50% or 80% of the average work time has elapsed since the assignment date and time.

Note that the notification contents of the reminder notification can be set discretionally, but may include, for example, a message indicating that the reminder notification has been sent at the average work time or a time based on the average work time.

In addition, the timing of the reminder notification based on the average work time can be set discretionally. For example, the reminder notification may be sent at two timings at which 50% and 80% of the average work time have elapsed. In this case, reminder notifications of different contents may be sent depending on the elapsed time. For example, the notification processing section 113 may vary contents or a display form of a message to be notified depending on the elapsed time.

In addition, the contents and notification timing of the reminder notification may be varied between the operator who has not yet started the task and the operator who has already started the task. For example, when a predetermined period of time based on the average work time has elapsed since a date and time at which an order is assigned to an operator, the notification processing section 113 determines whether the operator is an operator who has not yet started the task or an operator who has already started the task on the basis of the task history of that operator. The notification processing section 113 may then switch the notification contents of the reminder notification in accordance with the result of the determination.

In addition, for example, in the case of the operator who has not yet started the task, the notification processing section 113 may send a reminder notification at a timing at which 50% of the average work time has elapsed since the assignment date and time, and in the case of the operator who has already started the task, the notification processing section 113 may send a reminder notification at a timing at which 80% of the average work time has elapsed since the assignment date and time.

In addition, the notification processing section 113 may also send a reminder notification when the average work time (100%) has elapsed since the assignment date and time. When a reminder notification is sent at a timing at which the average work time has elapsed, it is favorable to send a reminder notification of different contents than the reminder notification sent at a timing at which the average work time has not elapsed. For example, the notification processing section 113 may vary contents or a display form of a message to be notified depending on whether the average work time has passed (exceeded) or not.

Note that the reminder notification is sent to the operator via the user terminal 20, but the notification method is not particularly limited. For example, the notification processing section 113 may display the reminder notification on a screen for viewing the workflow. In addition, information for displaying the reminder notification may be output to the user terminal 20. As an example, the notification processing section 113 may output information for displaying the reminder notification to the user terminal 20 using an e-mail or a short message service.

As described above, the server 10 of this embodiment sends a notification for prompting the execution of a task on the basis of the average work time derived from the work performance of each operator. This allows the server 10 to send a notification for prompting the execution of a task at a timing that is in line with an environment in which a workflow is provided and a task type actually executed, thus enhancing the operator's attention to the notification. Therefore, the server 10 can provide work support that reduces the occurrence of task omissions and delays.

The procedure of the processing performed by the work support system 1 will be described below. Note that in the following description in which the server 10 mainly acts, the server 10 may be regarded as the processing circuit 11. In addition, the procedure of the processing to be described below is only an example, and each processing may be modified as much as possible. Additionally, in the procedure of the processing to be described below, steps may be omitted, replaced, and added as appropriate depending on the embodiment.

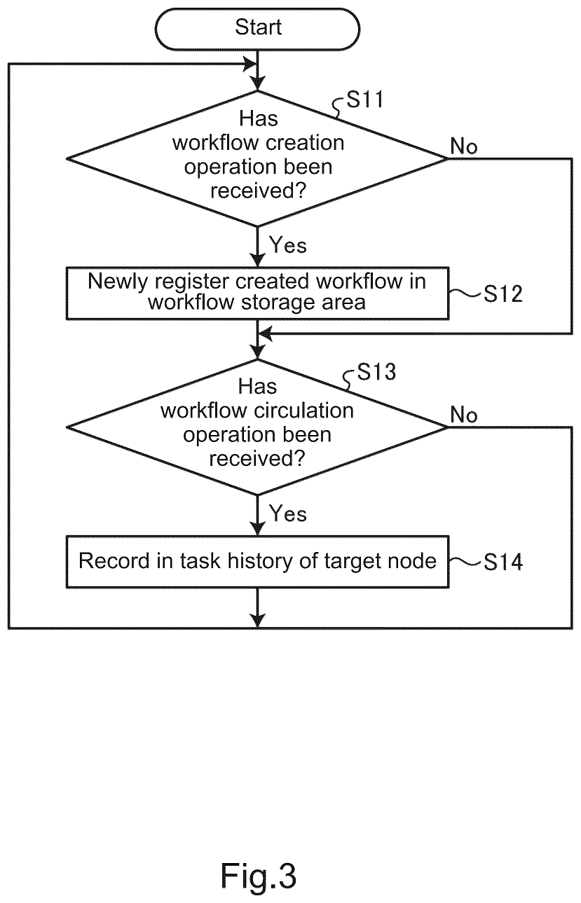

FIG. 3 is a flowchart showing an example of processing related to workflow management, which is performed by the server 10 according to the embodiment.

First, the workflow management section 111 determines whether or not a creation operation related to creation of a workflow has been received from the user terminal 20 operated by the drafter (Step S11). If a creation operation of a workflow has not been received (Step S11; No), the workflow management section 111 moves to Step S13.

Meanwhile, if a creation operation of a workflow has been received in Step S11 (Step S11; Yes), the workflow management section 111 newly registers a created workflow in the workflow storage area 131 (Step S12) and moves to Step S13. Specifically, the workflow management section 111 associates document data created by the drafter with a circulation route or the like and stores them in the workflow storage area 131. At that time, the workflow management section 111 registers the current date and time at which the workflow is registered, in the assignment date and time of the first node in the circulation order, to thereby assign a task to the first operator.

Note that the workflow management section 111 may send a reminder notification for prompting the execution of a task to the user ID (operator) associated with the first node in the circulation order in cooperation with the notification processing section 113.

Subsequently, the workflow management section 111 determines whether or not an operation performed on document data included in any workflow (hereinafter, referred to as circulation operation) has been received from the user terminal 20 operated by the operator (Step S13). If a circulation operation has not been received (Step S13; No), the workflow management section 111 returns to the processing of Step S11.

Meanwhile, if a circulation operation has been received (Step S13; Yes), the workflow management section 111 records a task type corresponding to the operation contents and a task date and time in association with each other in a task history of a node corresponding to the user ID of the operator who has performed the operation among the nodes included in the circulation flow of the workflow to be operated (Step S14). The workflow management section 111 then returns to the processing of Step S11.

Note that if a circulation operation corresponding to an approval task has been received, the workflow management section 111 registers a task date and time of the approval task in an assignment date and time of the next-order node, to thereby assign a task to the next-order operator. In addition, in this case, the workflow management section 111 may send a reminder notification for prompting the execution of the task to the user ID (operator) associated with the next-order node in cooperation with the notification processing section 113.

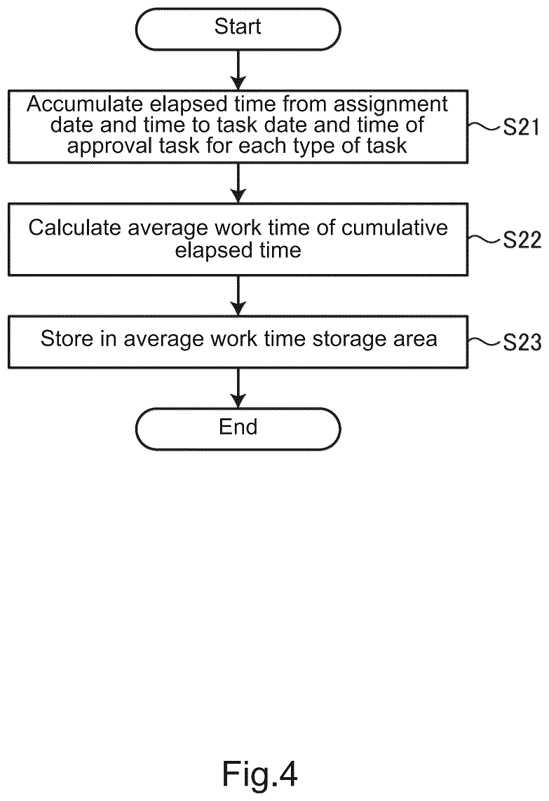

FIG. 4 is flowchart showing an example of processing related to calculation of an average work time, which is performed by the server 10 according to the embodiment. Note that the analysis processing section 112 mainly process the workflows stored in the workflow storage area 131 in sequence. The analysis processing section 112 may process workflows for which the approval tasks of all operators have been completed.

First, the analysis processing section 112 refers to the assignment date and time and the task history of each node included in the circulation flow of the workflow and accumulates the elapsed time from the assignment date and time to the task date and time at which the approval task has been performed, for each type of approval task (Step S21).

Subsequently, the analysis processing section 112 calculates an average work time for each type of approval task by dividing the cumulative time for each type of approval task by the total number of nodes from each of which the task date and time for that type is collected (Step S22). The analysis processing section 112 then associates the type of approval task and the average work time calculated for that type with each other to store them in the average work time storage area 132 (Step S23).

Note that the analysis processing section 112 may calculate a WF average work time by accumulating the time for each type of workflow from the assignment date and time in the first node to the task date and time at which an approval task has been executed in the last node and dividing the time by the total number of workflows of that type, for each workflow to be processed.

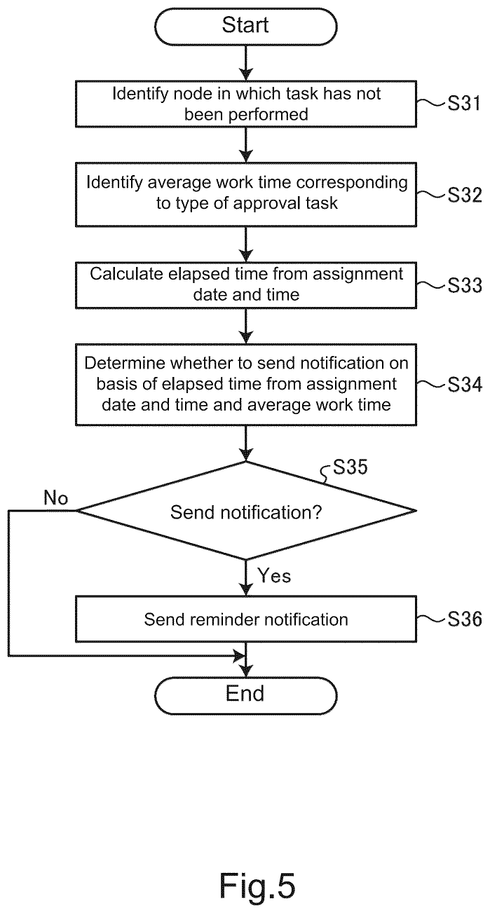

FIG. 5 is flowchart showing an example of processing related to the reminder notification, which is sent by the server 10 according to the embodiment. Note that the notification processing section 113 mainly process workflows in an uncompleted state among the workflows stored in the workflow storage area 131.

First, the notification processing section 113 identifies a node in which an assignment date and time has been registered but an approval task has not been recorded in the task history, among the nodes included in the task flow of the workflow (Step S31).

Subsequently, the notification processing section 113 refers to the average work time storage area 132 and identifies an average work time corresponding to the type of approval task performed in the identified node (Step S32). Next, the notification processing section 113 calculates an elapsed time from the assignment date and time to the current date and time in the identified node (Step S33).

Subsequently, the notification processing section 113 determines whether to send a reminder notification on the basis of the elapsed time to the current date and time calculated in Step S33 and the average work time identified in Step S32 (Step S34). For example, the notification processing section 113 determines whether or not the elapsed time from the assignment date and time has passed (exceeded) 80% of the average work time, and if the elapsed time has exceeded it, the notification processing section 113 determines that a reminder notification is to be sent.

If it is determined in Step S34 that a reminder notification is to be sent (Step S35; Yes), the notification processing section 113 sends a reminder notification to the operator of the user ID associated with the node identified in Step S31 (Step S36) and terminates the processing. In addition, if it is determined in Step S34 that a reminder notification is not to be sent (Step S35; No), the notification processing section 113 terminates this processing.

As described above, the server 10 of this embodiment calculates, for each of the workflows that define the order of assignment of tasks to be executed in sequence by a plurality of operators, an average time for each task type from the time when the order is assigned to an operator to the time when the operator executes the task, on the basis of the task history in which the type of the task executed by the operator and the execution date and time of the task are associated with each other. The server 10 then sends a notification to an operator who has not yet performed the task at a timing based on the average time corresponding to the type of that task.

This allows the server 10 to send a reminder notification at a timing that is in line with the environment in which the workflow is provided and the type of task actually executed, thus enhancing the attention, to the notification, of operators who have not yet performed tasks. Therefore, the server 10 can provide work support that reduces the occurrence of tasks omissions and delays.

Note that it is also possible to implement the embodiment descried above by changing and modifying as appropriate some of the configurations or functions that each of the above-mentioned apparatuses has. In this regard, some modifications according to the embodiment descried above will be described below as other embodiments. Note that in the following the points that differ from the embodiment described above will be mainly described, and detailed description will be omitted for points that are common to those already described. In addition, the modifications to be described below may be implemented individually or in combination as appropriate.

### Modification 1

In the embodiment described above, the server 10 is configured to send a reminder notification to an operator who actually handles a task of a workflow (hereinafter, also referred to as person in charge), but the destination of the reminder notification is not limited to the person in charge. For example, the notification processing section 113 may send a reminder notification to the person in charge and a superior of the organization to which the person in charge belongs, on the basis of the user management information associated with each user's affiliation, job title, authority, and other information.

For example, the notification processing section 113 may be configured to send a reminder notification to the person in charge when 50% or 80% of the average work time has elapsed since the assignment date and time, and send a reminder notification to the person in charge and the superior on the condition that 100% of the average work time has elapsed.

In addition, for example, the notification processing section 113 may be configured to send a reminder notification to the person in charge when the degree of importance associated with the workflow is “normal”, and send a reminder notification to the person in charge and the superior when the degree of importance is “important”, “urgent”, or the like.

According to the server 10 of this modification, the destination of the reminder notification can be changed in accordance with the elapsed time based on the average work time or the degree of importance of the workflow, so that a reminder notification can be effectively sent.

### Modification 2

In the embodiment described above, the server 10 is configured to send a reminder notification on the basis of the average work time of the approval task, but it is not limited thereto and may send a reminder notification on the basis of the WF average work time.

In this case, for example, the notification processing section 113 identifies a WF average work time corresponding to the type of workflow in an uncompleted state among the workflows stored in the workflow storage area 131. Next, the notification processing section 113 determines whether or not the time based on the identified WF average work time has elapsed since the assignment date and time of the first node in the circulation order included in the circulation route of that workflow. For example, the notification processing section 113 determines whether or not the time based on any of 50%, 80%, and 100% of the WF average work time has elapsed. When it is determined that the time based on the WF average work time has elapsed, the notification processing section 113 sends a reminder notification to an operator who has not performed the above-mentioned task.

Note that if the date and time at which the WF average work time (100% of the time) has elapsed since the assignment date and time of the first node passes the task deadline, it is favorable that the notification processing section 113 adjusts the percentage of the elapsed time based on the WF average work time such that a reminder notification is sent one or more times before the task deadline.

As described above, according to the server 10 of this modification, it is possible to provide an operator with a reminder notification that prompts the execution of a task on the basis of the WF average work time derived from the work performance of the operator.

### Other Embodiments

The information processing apparatus may be implemented by a single apparatus such as the server 10 or may be implemented by a plurality of apparatuses in which functions are distributed. In the latter case, the information processing apparatus includes the meaning of an information processing system including a plurality of apparatuses.

The embodiment described above may be applied not only to an apparatus but also to a method executed by an apparatus. The embodiment described above may be applied to a program that can cause a computer of an apparatus to execute functions. The embodiment described above may be applied to a recording medium that stores a program. The embodiment described above may be applied not only to a system but also to a method executed by a plurality of elements included in a system.

The processing circuit includes one or more circuits that implement a plurality of types of processing by a plurality of functions. For example, the circuit is a processor, an application specific integrated circuit (ASIC), or a field-programmable gate array (FPGA), but it is not limited thereto.

One or more circuits constituting a processing circuit each execute one or more processes in a plurality of processes. If the processing circuit includes a single circuit, the single circuit executes all of the plurality of processes. If the processing circuit includes a plurality of circuits, each of the plurality of circuits executes some of the plurality of processes. Some of the plurality of processes may be one of the plurality of processes or two or more of the plurality of processes. If the processing circuit includes a plurality of circuits, the plurality of circuits may be included in a single apparatus or may be distributed in a plurality of apparatuses.

A program may be transferred in a state of being stored in an apparatus or may be transferred in a state of not being stored therein. In the latter case, a program may be transferred over a network or may be transferred by being recorded on a recording medium. The recording medium is a non-transitory tangible medium. The recording medium is a computer readable medium. The recording medium only needs to be a medium that can store a program and is computer-readable, such as a CD-ROM or a memory card, regardless of the form of the medium.

The embodiments have been described in detail above, but the foregoing description is merely an example of the present embodiment in every point. It goes without saying that various improvements and variations can be made without departing from the scope of the present embodiment. In other words, in implementing the present embodiment, specific configurations according to the embodiments may be adopted as appropriate.

In short, the above embodiments are not limited as they are, but can be embodied by modifying the constituent elements without departing from the gist thereof in the stage of the implementation. In addition, various embodiments can be formed by combining as appropriate a plurality of constituent elements disclosed in the above embodiments. For example, some constituent elements can be deleted from all the constituent elements shown in the embodiments. Furthermore, constituent elements across the different embodiments may be combined as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a communication interface configured to communicate with a plurality of user terminals respectively operated by a plurality of operators via a network;
a storage device configured to store data of a workflow that defines an assignment order of tasks to be executed in sequence by the plurality of operators, the data of the workflow including a task history in which a type of the task executed by each of the operators and a date and time at which the task has been executed are associated with each other; and
a processing circuit configured to
record, in the storage device, when an operation for data included in the workflow is received from the user terminal operated by each operator via the communication interface, the type of the task corresponding to contents of the operation and the date and time at which the task has been executed, associated with each other in the task history corresponding to the operator who has performed the operation in the operated workflow,
calculate an average time for each type of the task from a time when an order is assigned to the operator to a time when the operator executes the task, on a basis of the task history, for each workflow, and
send a notification to an operator who has not performed the task at a timing based on the average time corresponding to the type of the task.

2. The information processing apparatus according to claim 1, wherein
the processing circuit is configured to calculate the average time for each type of task of advancing the order to a next-order operator, among the tasks that can be executed by the plurality of operators.

3. The information processing apparatus according to claim 1, wherein
the processing circuit is configured to calculate the average time for each type of task of approving a task executed in a preceding order, among the tasks that can be executed by the plurality of operators.

4. The information processing apparatus according to claim 1, wherein
the processing circuit is configured to send a notification when the task has not been performed at a time point at which a predetermined time based on the average time has elapsed since a date and time at which an order is assigned to the operator.

5. The information processing apparatus according to claim 1, wherein
the processing circuit is configured to determine whether the task has not yet been started or has been already started on a basis of the task history of the operator, at a time point at which a predetermined time based on the average time has elapsed since a date and time at which an order is assigned to the operator.

6. The information processing apparatus according to claim 5, wherein
the processing circuit is configured to determine that the task has not yet been started when the task history is left blank.

7. The information processing apparatus according to claim 5, wherein
the processing circuit is configured to switch contents of the notification in accordance with a result of the determination that the task has not yet been started or has been already started.

8. The information processing apparatus according to claim 5, wherein
the processing circuit is configured to switch a timing of the notification in accordance with a result of the determination that the task has not yet been started or has been already started.

9. The information processing apparatus according to claim 1, wherein
the processing circuit is configured to change the user terminal that is a destination of the notification in accordance with a degree of importance of the workflow.

10. An information processing method, comprising:
storing, in a storage device, data of a workflow that defines an assignment order of tasks to be executed in sequence by a plurality of operators, the data of the workflow including a task history in which a type of the task executed by each of the operators and a date and time at which the task has been executed are associated with each other;
recording, in the storage device, when an operation for data included in the workflow is received from a user terminal operated by each operator via a communication interface, the type of the task corresponding to contents of the operation and the date and time at which the task has been executed, associated with each other in the task history corresponding to the operator who has performed the operation in the operated workflow;
calculating an average time for each type of the task from a time when an order is assigned to the operator to a time when the operator executes the task, on a basis of the task history, for each workflow; and
sending a notification to an operator who has not performed the task at a timing based on the average time corresponding to the type of the task.
